(19) United States
(12) Patent Application Publication
(10) Pub. No.: US 2025/0199769 A1
(43) Pub. Date: Jun. 19, 2025

(54) ACCELERATOR FOR OPERATIONS BETWEEN PIECES OF DATA OF VARIOUS DATA TYPES AND OPERATION METHOD THEREOF

(71) Applicant: SEOUL NATIONAL UNIVERSITY R&DB FOUNDATION, Seoul (KR)

(72) Inventors: Jae-Joon KIM, Seoul (KR); Jaeyong JANG, Seoul (KR); Yulhwa KIM, Seoul (KR)

(21) Appl. No.: 18/984,507

(22) Filed: Dec. 17, 2024

(30) Foreign Application Priority Data
Dec. 19, 2023 (KR) 10-2023-0185500
Apr. 5, 2024 (KR) 10-2024-0046457

(51) Int. Cl. G06F 7/544

(52) U.S. Cl. CPC G06F 7/5443

(57) ABSTRACT

An operation accelerator for processing an operation between floating-point data and integer data includes a data converter configured to receive one of the integer data and the floating-point data as first input data and to output integer operation target data; a data setting unit configured to divide the integer operation target data into units of a same size and to transmit the integer operation target data to an arithmetic unit; the arithmetic unit configured to perform a multiply and accumulation (MAC) operation on second input data received as an integer and the integer operation target data received from the data setting unit; and a merger configured to adjust an operation result of the arithmetic unit by compensating for an original scale omitted in a process of dividing the integer operation target data into the units of the same size.

### CROSS-REFERENCE TO RELATED APPLICATION

This application claims the benefit under 35 USC 119 (a) of Korean Patent Application Nos. 10-2024-0046457 filed on Apr. 5, 2024 and 10-2023-0185500 filed on Dec. 19, 2023 in the Korean Intellectual Property Office, the entire disclosures of which are incorporated herein by reference for all purposes.

### BACKGROUND

### 1. Field

The present disclosure relates to an operation accelerator for operations between pieces of data of various types and an operation method of the operation accelerator.

### 2. Description of the Related Art

As the complexity of neural networks rapidly increases, research on quantization is actively being conducted to solve the complexity. Depending on structures and characteristics of respective neural networks, neural networks show different accuracies even when the same quantization method is applied. Due to this, a quantization method that may satisfy the target accuracy changes depending on neural networks, and accordingly, the neural networks are quantized into various data types depending on the user's needs. In particular, a neural network, such as CNN, shows good accuracy even when both an input and a weight are quantized into integers, but a generative artificial intelligence (AI), such as a large language model (LLM), has a problem in that accuracy decreases significantly when the input is quantized into an integer, and accordingly, many studies are being conducted on a quantization form for quantizing the weight into an integer and maintaining input data (activation) as floating-point expression. That is, an operation (FP×INT) in which an input is a floating-point type and a weight is an integer and an operation (INT×INT) in which both the input and weight are integers are used interchangeably.

In this regard, the conventional technology having an operation accelerator structure for a neural network quantized into an integer type with various bit-widths is known. In addition, a technology for converting an input having a floating-point type into an integer type through pre-alignment is also known. In addition, an operation accelerator structure that includes both an operator for floating-point data and an operator for integer data is also known, which is a structure that selects and uses one depending on situations. Therefore, the conventional operation accelerator has a problem in that only an operation (INT×INT) between pieces of integer data or an operation (FP×FP) between pieces of floating-point data may be performed, and an operation (FP×INT) between integer data and floating-point data may not be performed. In addition, when an operator that processes any one type is used, the operator that processes another type is idle, which reduces the overall efficiency of the accelerator.

Accordingly, the present disclosure proposes an operation accelerator that may efficiently perform operations between various types of data, such as floating-point data and integer data.

The known patent document related to this discloses Korean Patent Publication No. 2023-0094627 (Title: APPARATUS AND METHOD FOR COMPUTING FLOATING POINT BY IN-MEMORY COMPUTING).

### SUMMARY

The present disclosure provides an operation accelerator that may perform an operation on various types of data, such as floating-point data and integer data, and an operation method of the operation accelerator.

However, technical problems to be achieved by the present embodiment are not limited to the technical problems described above, and there may be other technical problems.

According to an aspect of the present disclosure, an operation accelerator for processing an operation between floating-point data and integer data includes a data converter configured to receive one of the integer data and the floating-point data as first input data and to output integer operation target data; a data setting unit configured to divide the integer operation target data into units of a same size and to transmit the integer operation target data to an arithmetic unit; the arithmetic unit configured to perform a multiply and accumulation (MAC) operation on second input data received as an integer and the integer operation target data received from the data setting unit; and a merger configured to adjust an operation result of the arithmetic unit by compensating for an original scale omitted in a process of dividing the integer operation target data into the units of the same size.

According to another aspect of the present disclosure, an operation method of an operation accelerator for processing an operation between floating-point data and integer data includes inputting the integer data and the floating-point data as first input data, and inputting integer data as second input data; outputting integer operation target data by converting the floating-point data of the first input data into the integer data; dividing the integer operation target data into units of a same size and transmitting the integer operation target data to an arithmetic unit; performing a multiply and accumulation (MAC) operation, by the arithmetic unit, on the integer operation target data divided into units of a same size and the second input data; and adjusting an operation result of the arithmetic unit by compensating for an original scale omitted in a process of dividing the integer operation target data into units of a same size.

According to the present disclosure, an operation accelerator that may efficiently perform operations between data of various types, such as floating point data and integer data, may be provided. Therethrough, operations between floating point-based activation and integer-based weights may be efficiently performed by a large language model and so on.

In addition, data divided into the same size is transmitted to an arithmetic unit regardless of a data type, and thus, operation efficiency of the arithmetic unit may be improved.

### BRIEF DESCRIPTION OF THE DRAWINGS

FIG. 1 illustrates an operation accelerator according to an embodiment of the present disclosure.

FIGS. 2A and 2B are diagrams illustrating a pre-alignment process of floating points according to an embodiment of the present disclosure.

FIG. 3 is a diagram illustrating a detailed configuration of a data convertor according to an embodiment of the present disclosure.

FIG. 4 illustrates a configuration of a data setting unit included in an operation accelerator, according to an embodiment of the present disclosure.

FIGS. 5A and 5B illustrate a configuration of an arithmetic unit included in an operation accelerator, according to an embodiment of the present disclosure.

FIG. 6 illustrates a configuration of an input bit merger included in an operation accelerator, according to an embodiment of the present disclosure.

FIG. 7 illustrates a configuration of a weighted bit merger included in an operation accelerator, according to an embodiment of the present disclosure.

FIG. 8 is a diagram illustrating an operation of an input bit merger and a weighted bit merger.

FIG. 9 illustrates a configuration of an operation accelerator according to an embodiment of the present disclosure.

FIG. 10 is a flowchart illustrating an operation method of an operator, according to an embodiment of the present disclosure.

### DETAILED DESCRIPTION

Hereinafter, embodiments of the present disclosure will be described in detail with reference to the attached drawings such that those skilled in the art to which the present disclosure belongs may easily practice the present disclosure. However, the present disclosure may be implemented in various different forms and is not limited to the embodiments described herein. In addition, in order to clearly describe the present disclosure in the drawings, parts that are not related to the description are omitted, and similar components are given similar reference numerals throughout the specification.

In the entire specification of the present disclosure, when a component is described to be “connected” to another component, this includes not only a case where the component is “directly connected” to another component but also a case where the component is “electrically connected” to another component with another element therebetween. In addition, when it is described that a portion “includes” a certain component, this means that the portion may further include another component without excluding another component unless otherwise stated.

In the present disclosure, a “portion” includes a unit realized by hardware, a unit realized by software, and a unit realized by using both. In addition, one unit may be realized by using two or more pieces of hardware, and two or more units may be realized by using one piece of hardware. Meanwhile, a “˜ portion” is not limited to software or hardware, and a “˜ portion” may be configured to be included in an addressable storage medium or may be configured to reproduce one or more processors. Therefore, in one example, “˜ portion” refers to components, such as software components, object-oriented software components, class components, and task components, and includes processes, functions, properties, and procedures, subroutines, segments of program code, drivers, firmware, microcode, circuits, data, databases, data structures, tables, arrays, and variables. The functions provided within the components and “portions” may be combined into a smaller number of components and “portions” or may be further separated into additional components and “portions”. Additionally, components and “portions” may be implemented to regenerate one or more central processing units (CPUs) included in a device or security multimedia card.

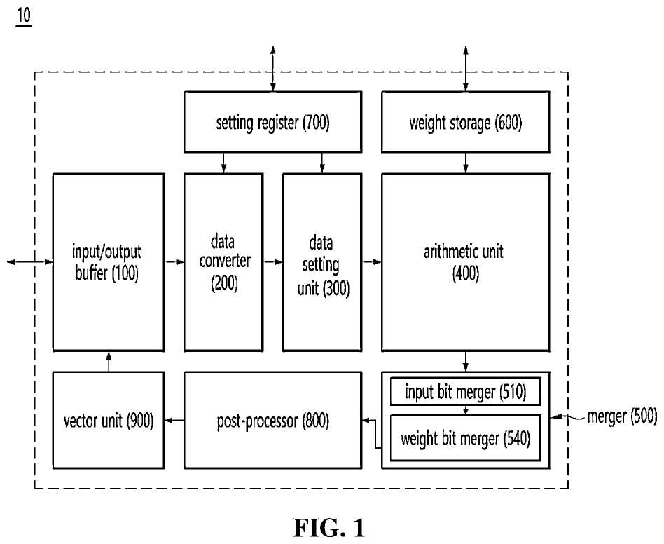

FIG. 1 illustrates an operation accelerator according to an embodiment of the present disclosure.

An operation accelerator 10 includes an input/output buffer 100, a data converter 200, a data setting unit 300, an arithmetic unit 400, and a merger 500. In addition, the operation accelerator 10 may further include a weight storage 600, a setting register 700, a post-processor 800, and a vector unit 900.

The input/output buffer 100 receives data of various types, such as integer data or floating-point data, as first input data from an external memory, or so on, and stores the data. In addition, the first input data is sent to the data converter 200. The first input data may represent activation values output from each layer that constitutes a learning model based on a deep neural network. In addition, the input/output buffer 100 receives a final output value output to the vector unit 900 and temporarily stores the final output value or outputs the final output value to an external memory or so on.

The data converter 200 receives integer data or floating-point data and outputs integer operation target data. When integer data is input, the integer data is bypassed without performing any conversion processing. When floating-point data is input, the floating-point data is converted into integer operation target data through pre-alignment. The data converter 200 finds the maximum exponent among multiple floating-point values included in the floating-point data and performs pre-alignment to move mantissa of each floating-point value by a difference between a maximum exponent value and exponent value of each floating-point value.

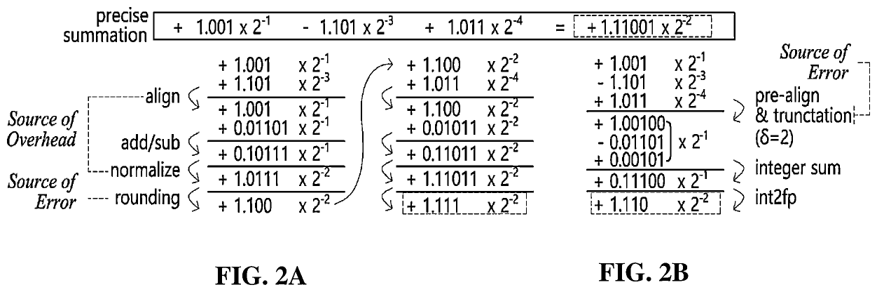

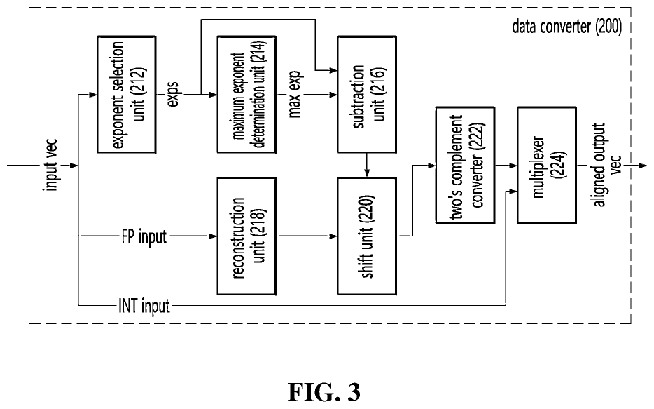

FIGS. 2A and 2B are diagrams illustrating a pre-alignment process of floating-point according to an embodiment of the present disclosure, and FIG. 3 is a diagram illustrating a detailed configuration of a data converter according to an embodiment of the present disclosure.

First, according to a standard method for representing floating points, the floating points are expressed by using bits representing a sign of a number, bits representing an exponent, and bits representing a mantissa (fraction, significant, or mantissa). However, due to the nature of a floating point method, have different scales.

In FIG. 2A, an operation of three numbers expressed as floating points is illustrated. First, subtraction is performed between a first number and a second number, and then a third number is added to a result of the subtraction. To do this, alignment is performed based on maximum exponents of the first number and the second number, and then an operation is performed, and then normalization and rounding are performed. In addition, alignment is performed based on a result of the operation and a maximum exponent of the third number, and then an operation is performed, and then normalization and rounding are performed.

In contrast to this, the present disclosure uses a method for pre-aligning and operating all operation target numbers before performing the operation, as illustrated in FIG. 2B. That is, a maximum exponent among the operation target numbers is found, and alignment for matching scales of respective numbers is performed based on the maximum exponent. That is, each mantissa is aligned based on the maximum exponent among multiple floating-point values. In this case, the mantissa of each floating-point is moved by a difference between a maximum exponent value and an exponent value of each floating-point value. For example, when a floating-point has an exponent that is less than a maximum exponent, the mantissa is moved to the right. Then, a value of the mantissa moved to the right for each data may be recorded and used.

Referring to FIG. 3, the data converter 200 may include an exponent selection unit 212, a maximum exponent determination unit 214, a subtraction unit 216, a reconstruction unit 218, a shift unit 220, a two's complement converter 222, and a multiplexer 224.

The exponent selection unit 212 considers that bit positions at which exponents are located are different depending on types of inputs, and extracts exponent values exps from floating point data. The maximum exponent determination unit 214 receives the exponent values extracted by the exponent selection unit 212, and determines a maximum exponent value max exp from the exponent values. The subtraction unit 216 determines a difference between the exponent value of each floating point data and the previously determined maximum exponent, and calculates a shift value indicating a degree to which the mantissa has to be shifted from each floating point data. In addition, the difference value is transmitted to the shift unit 220.

The reconstruction unit 218 extracts an exponent and mantissa of an input value by considering types of an input, calculates a hidden bit by using the exponent value, and then transmits the hidden bit and a mantissa value to the shift unit 220.

The shift unit 220 applies the shift value indicating a degree to which the mantissa received from the subtraction unit 216 has to be shifted to the mantissa received from the reconstruction unit 218, thereby moving the mantissa, and thereby converts the mantissa of the floating-point data into a fixed-point type having the same scale.

The two's complement converter 222 then converts the form into a two's complement type by using a sign of each input.

In addition, when the input data is INT4 or INT8, all input elements may be previously interpreted as fixed-point data having the same scale, thereby being bypassed and directly input to the multiplexer 224 without going through a pre-alignment step.

In this way, even when the input data is floating-point data such as FP32, FP16, and BF16 or integer data such as INT4 and INT8, the data converter 200 may convert all input data into fixed-point data having the same scale, and accordingly, the present disclosure may efficiently support various input data formats.

Referring again to FIG. 1, the data setting unit 300 divides integer operation target data output by the data converter 200 into units of the same size and transmits the divided integer operation target data to the arithmetic unit 400.

As described above, the data converter 200 converts all types of input data into fixed-point numbers with the same scale, but because bit-widths of the mantissa of each data type are different from each other, the input data has different bit-widths depending on types of the original input data. For example, when the input data is FP16, BF16, FP32, INT4 or INT8, the different bit-widths of each input data passing through the data converter 200 are efficiently solved.

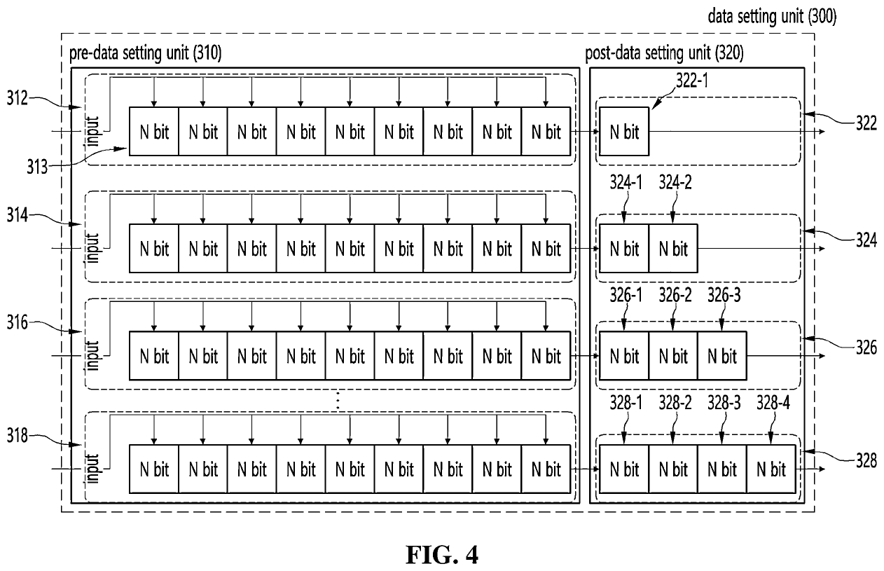

FIG. 4 illustrates a configuration of the data setting unit 300 included in an operation accelerator according to an embodiment of the present disclosure.

The data setting unit 300 may include a pre-data setting unit 310 and a post-data setting unit 320.

The pre-data setting unit 310 may include a plurality of serializers 312 to 318 that convert input data into serial data and output the converted data. The plurality of serializers 312 to 318 are arranged in a plurality of rows and convert input data into serial data and output the converted data. The plurality of serializers 312 to 318 may each include a plurality of flip-flops 313 connected in series to each other, which may store maximum bit-widths of respective pieces of the data converted by the data converter 200. In addition, the plurality of serializers 312 to 318 divide data into chunk units of a preset size to resolve the fact that the bit-widths of the input data converted into fixed-points are different from each other and stores the divided data in each flip-flop 312. In addition, the data divided into the same size is sequentially transmitted to the post-data setting unit 320, and accordingly, data of a constant size may be transmitted regardless of a data format or bit-widths of the input data. In this case, the chunk unit may be 4 bits by way of example, but may also be changed to another size.

The post-data setting unit 320 temporarily stores data of a chunk unit received from the pre-data setting unit 310 and then transmits the data of a chunk unit to the arithmetic unit 400 in synchronization with an appropriate timing. To this end, the post-data setting unit 320 may include a plurality of buffers 322 to 328 that temporarily store data of the plurality of serializers 312 to 318. The plurality of buffer units 322 to 328 operate in a first in first out (FIFO) manner, and the number of buffers included in each of the plurality of buffer units 322 to 328 is set differently.

For example, when the arithmetic unit 400 includes K (K is a plural natural number) processing units, the arithmetic unit 400 also includes K buffer units, the buffer unit 322 in the first row includes one buffer, the buffer unit 324 in the second row includes two buffers continuously connected to each other, and the buffer unit 328 in a k^{th} row (k is a natural number that is less than or equal to K) may include k buffers continuously connected to each other. In addition, the plurality of buffer units 322 to 328 may each receive data of a chunk unit from each of the plurality of serializers 312 to 318 arranged in the same row, and then stores data in each buffer that stores data of the same size.

Timings at which the plurality of buffer units 322 to 328 outputs data for each row may be different from each other.

Although the plurality of serializers 312 to 318 output chunk data at the same timing, the number of buffers included in each of the plurality of buffer units 322 to 328 changes, and accordingly, the timing at which data is transmitted to the arithmetic unit 400 changes. In other words, a delay occurs by a difference in the number of buffers included in each of the plurality of buffer units 322 to 328. For example, data is transmitted, at a first point in time, to a buffer 322-1 of the first buffer unit 322, a buffer 324-1 of the second buffer unit 324, a buffer 326-1 of the third buffer unit 326, and a buffer 328-1 of the fourth buffer unit 328. Thereafter, data of the buffer 322-1 is output to the arithmetic unit 400 at a second point in time, but data of the buffer 324-1 is transmitted to a next buffer 324-2, and accordingly, the data is delayed by one cycle. Similarly, the same delay occurs in the third buffer unit 326 and the fourth buffer unit 328. Therefore, the data stored in the buffer 328-1 of the fourth buffer unit 328 is transmitted to the arithmetic unit 400 after being delayed by three cycles. A configuration of the post-data setting unit 320 is designed by considering the fact that the arithmetic unit 400 has a systolic array structure. That is, the arithmetic unit 400 having the systolic array structure performs multiplication on an M*N matrix, which is a structure in which data is input such that the data input to each row or column is delayed by one cycle for each row or column, and accordingly, by considering the structure, the post-data setting unit 320 outputs data with a delay of one cycle for each row.

In this way, the data setting unit 300 transmits data having a constant size to the arithmetic unit 400 regardless of a data format or bit-width of input data, and accordingly, the arithmetic unit 400 may always process chunk data having the same size regardless of whether the type of input data is BF16, FP16, FP32, INT4, or INT8, and thus, the arithmetic unit 400 may be used more efficiently.

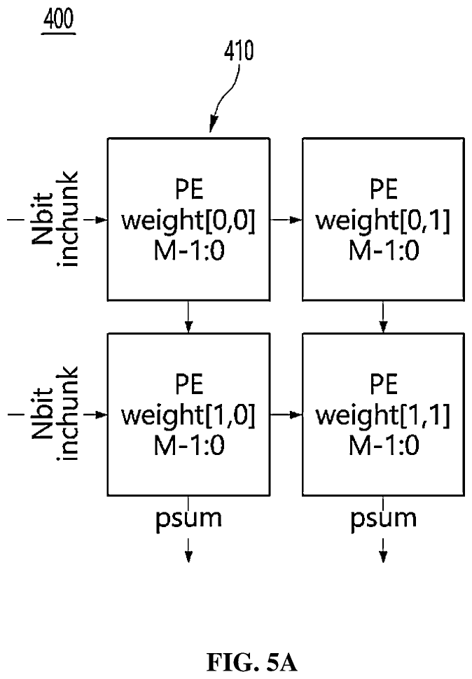

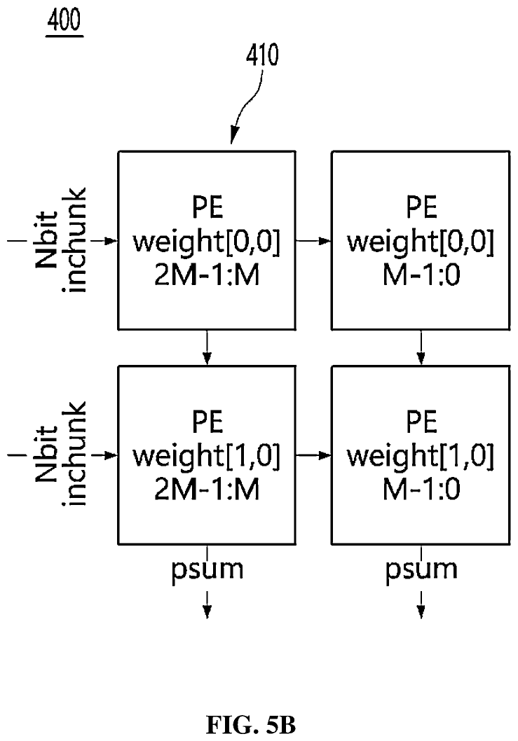

FIG. 5A and FIG. 5B illustrate configurations of an arithmetic unit included in an operation accelerator according to an embodiment of the present disclosure.

The arithmetic unit 400 includes a plurality of processing units (processing elements: PE) that perform multiply and accumulation (MAC). A plurality of processing units 410 match one-to-one to the respective buffer units 322, 324, 326, and 328 of the post-data setting unit 320, and receive chunk data in which input data having equally divided sizes.

In addition, each of the plurality of processing units 410 multiplies input data representing activation by weight data, and the weight data is input as integer data. FIG. 5A illustrates a case where integer data representing a weight has M bits, and FIG. 5B illustrates a case where the integer data representing a weight has 2M bits. In addition, both are illustrated as examples of a 2×2 size.

Each of the plurality of processing units 410 stores a weight in an internal register, receives input data and a partial sum output by another processing unit, and performs “an input×a weight+a partial sum”, which is called a MAC operation. Because a configuration of the processing unit 410 that performs the MAC operation corresponds to the known art, detailed descriptions thereof are omitted.

The arithmetic unit 400 receives input data in the horizontal direction and propagates a partial sum in the vertical direction and performs matrix multiplication in the same manner as the general systolic array. In addition, depending on types of weight data, the weight data may be divided into chunks of M bits and stored in each column of the plurality of processing units 410. FIG. 5B illustrates that a weight having a 2M bit type is divided and stored in columns of two processing units.

In this way, the arithmetic unit 400 receives input data divided into the same bit size from the data setting unit 300, and thus, operation efficiency may be increased.

Next, the merger 500 may include an input bit merger 510 and a weight bit merger 540.

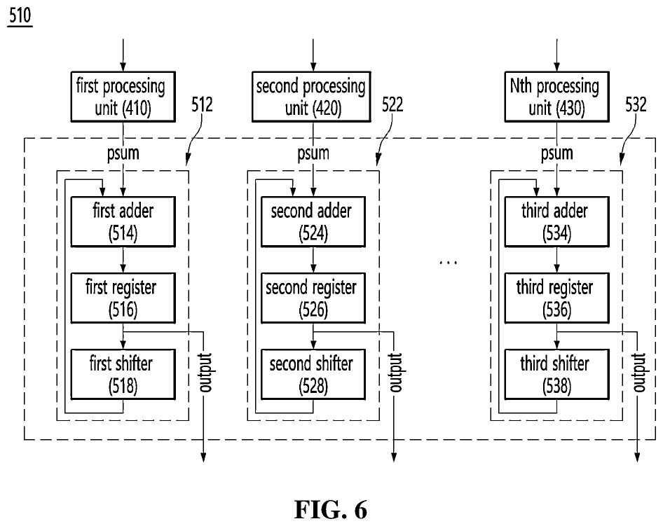

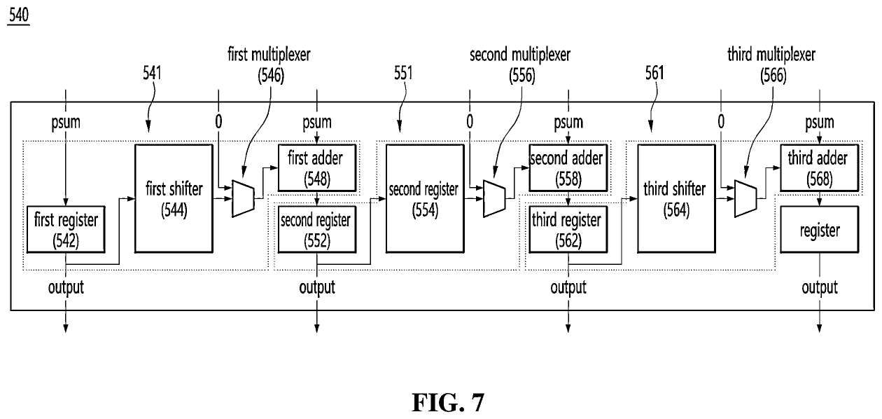

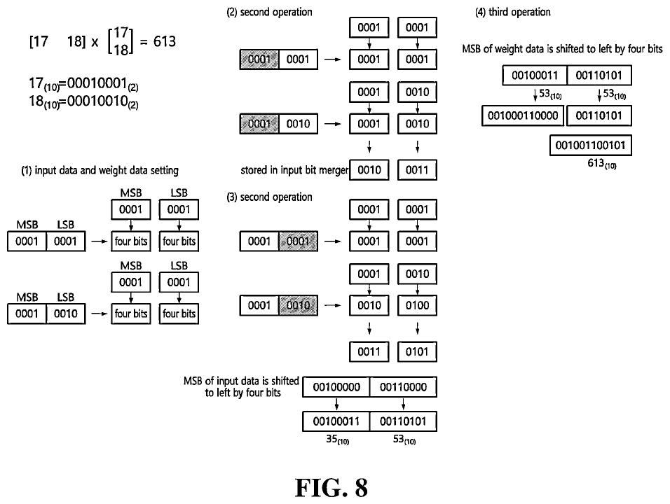

FIG. 6 illustrates a configuration of the input bit merger 510 included in an operation accelerator according to an embodiment of the present disclosure, FIG. 7 illustrates a configuration of the weight bit merger 540 included in an operation accelerator according to an embodiment of the present disclosure, and FIG. 8 is a diagram illustrating operations of the input bit merger 510 and the weight bit merger 540.

The input bit merger (input bit-plane merger) 510 compensates for an effect of dividing input data into N-bit units by using the data setting unit 300 and then transmitting the divided input data to the arithmetic unit 400. The input bit merger 510 performs an accumulation operation on a partial sum psum output from the columns of the processing units 410, 420, and 430 by using an adder, a register, a shifter, and so on. The input bit merger 510 may include a plurality of merge processing units 512, 522, and 532 that receive partial sums output through the columns of respective processing units and perform an operation of adjusting an operation result for integer operation target data requiring scale compensation. Each of the plurality of merge processing units 512, 522, and 532 includes an adder, a register, and a shifter that are sequentially connected to each other, the adder receives each partial sum output through the column of the processing unit, the register temporarily stores an output of the adder, and the shifter shifts an output of the register to the left or right to compensate for the number of digits. In this way, a value obtained by compensating for the number of digits of the partial sum is fed back to the adder, and a sum operation is performed again.

For example, a first adder 514 of the first merge processing unit 512 may store the first partial sum output from the first processing unit 410 in a first register 516, and then, the first partial sum is shifted to the left by N bits by a first shifter 518. In addition, the first partial sum shifted to the left by N bits is fed back to the first adder 514, and the first adder 514 adds the first partial sum shifted to the left by N bits to a second partial sum output from the first processing unit 410. In this way, input data of different types may be divided into N-bit units of the same size, and then the same operation may be performed by the arithmetic unit 400, and a size according to the number of digits of each input data may be compensated for later.

Referring to FIG. 8, assuming that a matrix is multiplied as an example, numbers corresponding to each binary number of 17 and 18 may be respectively input as input data and weight data. The input data is divided into 4-bit chunk data and is input to the arithmetic unit 400 by the data setting unit 300, and the weight data may also be divided into 4-bit chunk data and is input to the arithmetic unit 400. In addition, in a first operation process, an MSB of the first input data 17 is multiplied by 4-bit MSB of first weight data, an MSB of the second input data 18 is multiplied by 4-bit MSB of second weight data, and results of multiplication are summed and transmitted to the first adder 514 and an input bit merger as the first partial sum and then stored in the first register 516. In a second operation process, the LSB of the first input data 17 is multiplied by 4-bit MSB of first weight data, the LSB of the second input data 18 is multiplied by 4-bit MSB of second weight data, and results of multiplication are summed and transmitted to the first adder 514 and an input bit merger as the second partial sum. In this case, the first partial sum stored in the first register 516 is shifted to the left by 4 bits. In addition, the shifted first partial sum is added to a newly input second partial sum, and the result is output as 35 for the first column. Similarly, when the input data and the LSB of weight data are used to perform the first and second operation processes in the same manner, the result is output as 53 for the second column.

In this way, the input bit merger 510 compensates for an original scale of the divided data of which original scale is omitted in the process of dividing the input data into N-bit units of the same size. As in the example, the MSB data and LSB data are multiplied in the same manner by a processing unit, and because an original scale of the MSB data is omitted in this process, compensation is performed by adjusting the number of digits of the multiplication result of the MSB data.

The weight bit merger (weight bit-plane merger) 540 compensates for an effect of dividing the weight data into M-bit units and then transmitting the divided data to the arithmetic unit 400. The weight bit merger 540 performs an accumulation operation on the partial sum psum output from the input bit merger 510 by using a register, shifter, mux, adder, and so on.

The partial sum output from the input bit merger 510 is propagated to the right and is accumulated. When the partial sums are propagated to the right, the partial sums are shifted to the left by M bits, causing the weight data separated into M bit units to be equally calculated by the arithmetic unit 400, and a size according to the number of digits of each weight data may be compensated for later.

First, the first partial sum is stored in a first register 542, and then shifted to the left by M bits by a first shifter 544. The shifted first partial sum passes through a first multiplexer 546 and is added to the second partial sum by a first adder 548.

Referring again to FIG. 8 previously described as an example, a weight bit merging process may be confirmed in the third operation process. The weight data is also divided into a 4-bit unit and may be divided into an MSB and an LSB. In an operation process of the arithmetic unit 400, the MSB and LSB are not distinguished, and the operation is performed in the same 4-bit unit, and then the number of digits of the MSB of the weight data is reflected and compensated for later. That is, among values 35 and 53 output in the second operation process, an operation is performed to shift 35, to which the MSB of the weight data is applied, to the left by four bits, and then the values are finally summed.

For reference, a multiplexer selectively adjusts whether to further propagate the value, to which the shift operation is applied, to the right, and when zero is input as a selection signal, the shifted operation result is stopped from being propagated to the right.

In this way, when dividing the weight data into M-bit units of the same size, the weight bit merger 540 compensates for original digits of the divided data later.

Referring again to FIG. 1, the weight storage 600 stores the second input data received in an integer form and transmits the second input data to the arithmetic unit 400. The second input data may represent a weight multiplied by an activation value output from a previous layer among respective layers constituting a learning model based on a deep neural network, or a weight in a perceptron that simulates neurons. In the present disclosure, the second input data is divided into M-bit units to be used for a MAC operation, and MSB data or so on of which digits are omitted in this process are compensated for later by the merger 500 as described above.

The setting register 700 may store a flag value indicating the type of data input as the first input data and the second input data. The first input data may include a flag value for a data type, such as BF16, FP16, FP32, INT4, or INT8, or the second input data may include a flag value for a data type, such as INT4 or INT8. These flag value is transmitted to the data converter 200 to convert floating point data into integer operation target data, or to allow integer data to be bypassed. In addition, the flag value may include information on data size, and the data setting unit 300 controls operations of the pre-data setting unit 310 and the post-data setting unit 320 according to the data size.

The post-processor 800 may include an accumulation buffer that performs Int2fp logic and accumulation logic as an operation of post-processing the operation result output from the merger 500 and stores the accumulation results. The Int2fp logic converts integer data output from the merger 500 into floating point format. As described above, the present disclosure finds the maximum exponent among the numbers to be operated, performs pre-alignment for matching scales of each number based on the maximum exponent, and performs all operations. The Int2fp logic may perform reverse conversion according to the floating point format by combining the maximum exponent found in the pre-alignment with the integer output result of the merger 500.

The accumulation logic sums the floating point format values output through the Int2fp logic and outputs the accumulation operation result. The accumulation buffer may temporarily store the accumulation operation result of the accumulation logic.

The vector unit 900 transmits the accumulation operation result received from the accumulation buffer to the input/output buffer 100. The vector unit 900 may perform a single instruction multiple data (SIMD) operation, for example, an operation of the form of a*x+b to perform dequantization.

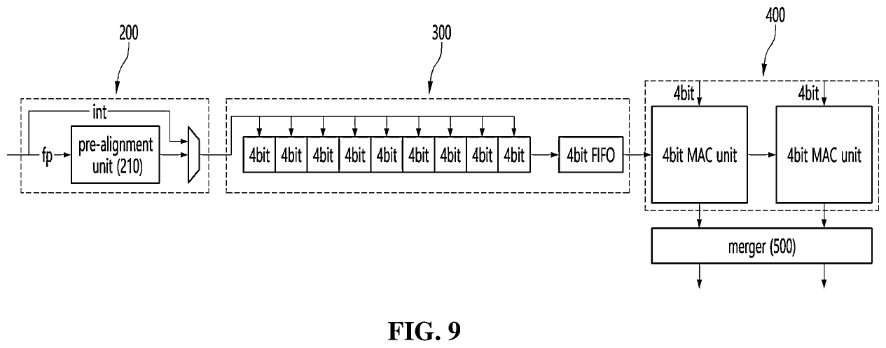

FIG. 9 illustrates a configuration of an operation accelerator according to an embodiment of the present disclosure.

As illustrated in FIG. 9, the operation accelerator 10 includes the data converter 200, the data setting unit 300, the arithmetic unit 400, and the merger 500.

When input data is integer data, such as INT4 or INT8, the data converter 200 bypasses the pre-alignment unit 210 and transfers the input data to the data setting unit 300. In addition, when the input data is floating point data, the data converter 200 performs pre-alignment and then transmits pre-aligned data to the data setting unit 300.

In addition, the data setting unit 300 divides the integer operation target data into 4-bit units and transmits the divided data to the arithmetic unit 400. Then, the arithmetic unit 400 transmits the weight data to each processing unit in the form of 4-bit units.

For example, when the first input data is FP32 and the second input data is INT8, the first input data requires 35 bits, and accordingly, the data setting unit 300 sequentially stores the data divided into 4-bit units in nine flip-flops. In addition, the post-data setting unit 320 sequentially outputs the data during nine cycles. In addition, the arithmetic unit 400 divides the second input data into 4-bit units and transmits the divided data to each processing unit.

In addition, when the first input data is BF16 and the second input data is INT4, the first input data is 15 bits, and accordingly, the data setting unit 300 sequentially stores the data divided into 4-bit units in four flip-flops. In addition, the post-data setting unit 320 sequentially outputs the data during four cycles. In addition, the arithmetic unit 400 transmits the second input data to each processing unit in 4-bit units.

In addition, when the first input data is INT8 and the second input data is INT8, the first input data requires 8 bits, and accordingly, the data setting unit 300 sequentially stores the data divided into 4-bit units in two flip-flops. In addition, the post-data setting unit 320 sequentially outputs the data during two cycles. In addition, the arithmetic unit 400 divides the second input data into 4-bit units and transmits the divided data to each processing unit.

In this way, because the first input data uses data type, such as BF16, FP16, FP32, INT4, or INT8, and the second input data uses the data type, such as INT4 or INT8, an operation accelerator that may use a total of 10 data type combinations may be provided.

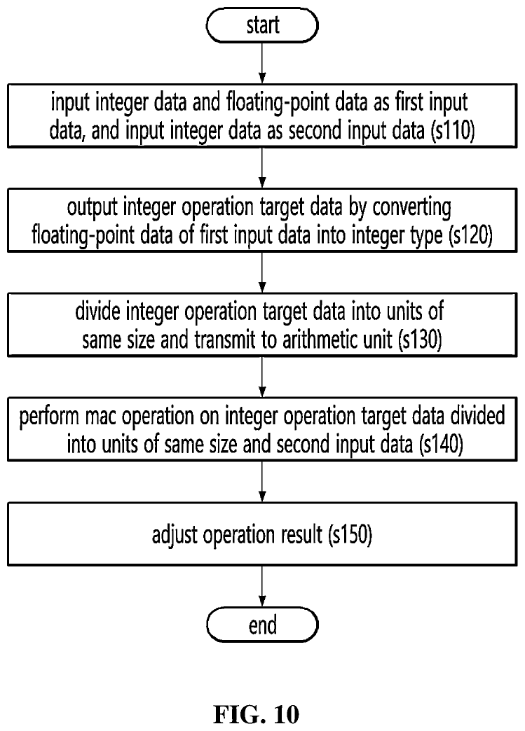

FIG. 10 is a flowchart illustrating an operation method of an arithmetic unit, according to an embodiment of the present disclosure.

First, integer data and floating-point data are input as first input data, and integer data is input as second input data (S110).

Next, floating-point data of the first input data is converted into integer data, and integer operation target data is output (S120).

Next, the integer operation target data is divided into units of the same size and transmitted to the arithmetic unit 400 (S130).

Next, the arithmetic unit 400 performs a MAC operation on the integer operation target data divided into units of the same size and the second input data (S140).

Next, an operation result of the arithmetic unit 400 is adjusted by compensating for an original scale omitted in the process of dividing the integer operation target data into units of the same size (S150).

A method according to an embodiment of the present disclosure may be performed in the form of a recording medium including instructions executable by a computer, such as a program module executed by a computer. A computer readable medium may be any available medium that may be accessed by a computer and includes both volatile and nonvolatile media, removable and non-removable media. Also, the computer readable medium may include a computer storage medium. A computer storage medium includes both volatile and nonvolatile media and removable and non-removable media implemented by any method or technology for storing information, such as computer readable instructions, data structures, program modules or other data.

In addition, although the method and system of the present disclosure are described with respect to specific embodiments, some or all of components or operations thereof may be implemented by using a computer system having a general-purpose hardware architecture.

The above description of the present disclosure is intended to be illustrative, and those skilled in the art will appreciate that the present disclosure may be readily modified in other specific forms without changing the technical idea or essential characteristics of the present disclosure. Therefore, the embodiments described above should be understood as illustrative in all respects and not limiting. For example, each component described in a single type may be implemented in a distributed manner, and likewise, components described in a distributed manner may be implemented in a combined form.

The scope of the present application is indicated by the claims described below rather than the detailed description above, and all changes or modified forms derived from the meaning, scope of the claims, and their equivalent concepts should be interpreted as being included in the scope of the present application.

What is claimed is:

1. An operation accelerator for processing an operation between floating-point data and integer data, the operation accelerator comprising:
a data converter configured to receive one of the integer data and the floating-point data as first input data and to output integer operation target data;
a data setting unit configured to divide the integer operation target data into units of a same size and to transmit the integer operation target data to an arithmetic unit;
the arithmetic unit configured to perform a multiply and accumulation (MAC) operation on second input data received as an integer and the integer operation target data received from the data setting unit; and
a merger configured to adjust an operation result of the arithmetic unit by compensating for an original scale omitted in a process of dividing the integer operation target data into the units of the same size.

2. The operation accelerator of claim 1, wherein
the arithmetic unit performs the MAC operation by dividing the second input data into units of a same size, and
the merger adjusts the operation result of the arithmetic unit by compensating for an original scale omitted in a process of dividing the second input data into units of a same size.

3. The operation accelerator of claim 1, wherein
the data converter finds a maximum exponent value among a plurality of floating-point values and performs pre-alignment for shifting a mantissa of each floating-point value by a difference between the maximum exponent value and an exponent value of each floating-point value, for the floating-point data and bypasses the integer data without performing the pre-alignment.

4. The operation accelerator of claim 1, wherein
the data setting unit includes: a plurality of serializers arranged in a plurality of rows according to a number of processing units included in the arithmetic unit, configured to serially convert an output of the data converter, configured to divide the integer operation target data into chunks of a same size, and configured to sequentially output the integer operation target data; and a plurality of buffer units arranged in a plurality of rows to be connected to each serializer, configured to receive outputs of the plurality of serializers in chunk units, and configured to sequentially output the output in the chunk units, and
as a number of rows is increased, the plurality of buffer units delay a timing, at which data of chunk units is output, by one cycle.

5. The operation accelerator of claim 4, wherein
the plurality of buffer units are K buffer units corresponding to a number of K processing units (K is a plural natural number), and
a k^{th} buffer unit arranged in a k^{th} row (k is a natural number that is less than or equal to K) includes k buffers in which the data of the chunk units is stored and which are connected in series to each other.

6. The operation accelerator of claim 1, wherein
the merger includes an input bit merger configured to adjust the operation result by compensating for an original scale omitted in a process of dividing the integer operation target data into N-bit (N is a natural number that is plural) units,
the input bit merger includes a plurality of merge processing units configured to receive a partial sum output from each of the plurality of processing units included in the arithmetic unit and to adjust the operation result for integer operation target data that requires scale compensation,
each of the plurality of merge processing units includes an adder configured to receive the partial sum, a register storing an output of the adder, and a shifter configured to adjust a number of digits for an output of the register and to feed back a value obtained by adjusting the number of digits to the adder, and
a first merge processing unit shifts a first partial sum output from a first processing unit and stored in the first register to the left by N bits through a first shifter and feeds the first partial sum back to a first adder, and the first adder adds the first partial sum shifted to the left by N bits to a second partial sum output from the first processing unit and outputs the summed partial sum.

7. The operation accelerator of claim 6, wherein
the merger includes a weight bit merger configured to adjust the operation result by compensating for an original scale omitted in a process of dividing the second input data into M-bit (M is a plural natural number) units,
the weight bit merger includes a plurality of merge processing units configured receive an output of the input bit merger and to adjust the operation result for second input data that requires scale compensation, and includes a register configured to store a first output of the input bit merger, a shifter configured to adjust a number of digits for an output of the register and output a value obtained by adjusting a number of digits, and an adder configured to add an output of the shifter to a second output of the input bit merger, and
the first merge processing unit shifts a first output stored in the first register to the left by M bits through the first shifter and outputs the first output to the first adder, and the first adder adds the first output shifted to the left by M bits to the second output of the input bit merger and outputs the summed output.

8. The operation accelerator of claim 1, wherein
the data converter outputs one of 4-bit integer data, 8-bit integer data, 16-bit floating point data, 32-bit floating point data, and 16-bit brain floating point data as integer data of a same scale.

9. The operation accelerator of claim 1, wherein
the first input data is an activation value, and the second input data is a weight value.

10. An operation method of an operation accelerator for processing an operation between floating-point data and integer data, the operation method comprising:
inputting the integer data and the floating-point data as first input data, and inputting integer data as second input data;
outputting integer operation target data by converting the floating-point data of the first input data into the integer data;
dividing the integer operation target data into units of a same size and transmitting the integer operation target data to an arithmetic unit;
performing a multiply and accumulation (MAC) operation, by the arithmetic unit, on the integer operation target data divided into units of a same size and the second input data; and
adjusting an operation result of the arithmetic unit by compensating for an original scale omitted in a process of dividing the integer operation target data into units of a same size.

11. The operation method of claim 10, wherein,
in the performing of the MAC operation, the second input data is divided into units of a same size to perform the MAC operation, and
in the adjusting of the operation result, the operation result is adjusted by additionally compensating for an original scale omitted in a process of dividing the second input data into units of a same size.

12. The operation method of claim 10, wherein,
in the outputting of the integer operation target data, a pre-alignment is performed for the floating point data by finding a maximum exponent value among a plurality of floating point values and shifting a mantissa of each floating point by a difference between the maximum exponent value and an exponent value of each of the plurality of floating point values, and
the integer data is bypassed without being pre-aligned.

13. The operation method of claim 10, wherein
the first input data is an activation value, and the second input data is a weight value.

14. A non-transitory recording medium in which a computer program for performing the operation method of the operation accelerator according to claim 10 is recorded.
